(19) United States
(12) Patent Application Publication
(10) Pub. No.: US 2005/0198684 A1
(43) Pub. Date: Sep. 8, 2005

(54) Method and apparatus for providing a DSG to an OOB transcoder

(76) Inventors: Christopher J. Stone, Newtown, PA (US); Richard S. Grzeczkowski, Warrington, PA (US)

Correspondence Address: Motorola, Inc., 101 Tournament Drive, Horsham, PA, 19044, US

(21) Appl. No.: 10/795,872

(22) Filed: Mar. 8, 2004

(51) Int. Cl. H04N 7/16; H04L 5/14; H04N 7/173

(52) U.S. Cl. 725/111; 725/100; 725/131; 725/139; 725/151

(57) ABSTRACT

The present invention is a method and apparatus for providing a DSG to OOB transcoder in a cable television system comprising a legacy set-top device 102. In the first embodiment, a one-way DSG to OOB transcoder 202 acts as a proxy device for OOB messages to the DSG tunnel 128. Once an OOB message is generated, the OOB message is transmitted to the DSG tunnel 128. The DSG to OOB transcoder 202 of the present invention then captures the OOB message, and communicates the OOB message to the legacy set-top device 102. In a second embodiment of the invention, the legacy set-top device 102 may communicate return communications to the DSG to OOB transcoder 402 by generating a QPSK message. The QPSK message is then translated to an OOB message comprising DOCSIS content.

### FIELD OF THE INVENTION

The present invention relates to the field of cable television systems, and more particularly, to a method and apparatus for providing OOB messaging functionality to set-top devices without DOCSIS capability in a DOCSIS DSG cable television system.

### BACKGROUND OF THE INVENTION

Currently, cable operators are beginning to convert their cable television systems to a technology specification known as the Data Over Cable Interface Specification (DOCSIS). Among its many advantages, DOCSIS brings seamless interoperability to cable technology. Thus, cable architecture components such as cable modems and set top devices can be “mixed and matched” freely, without regard to the particular manufacturer of each component of the cable television system.

Recently, several players in the cable television industry joined together to develop a specification for defining the DOCSIS interface requirements between the cable operator and the equipment at each cable subscriber residence (referred to as “customer premises equipment,” or CPE). This specification, referred to as the DOCSIS Set-top Gateway Interface (DOCSIS DSG or DSG) provides for transport of out of band (OOB) messaging to set-top devices, comprising one or more DOCSIS tuners, utilizing existing DOCSIS cable modem termination systems (CMTSs) and radio frequency (RF) signals. These OOB messages may include, but are not limited to, messages containing system information, emergency alert information, and conditional access information. These set-top devices equipped with one or more DOCSIS tuners are referred to as “DSG compatible” set-top devices.

However, a cable television network may contain one or more set-top devices that do not include a DOCSIS compatible tuner. These set-top devices are referred to as “legacy set-top devices.” Without a DOCSIS compatible tuner, a legacy set-top device cannot receive OOB messaging from the CMTS.

While these legacy set-top devices can still function in the DOCSIS DSG environment, i.e. receive OOB messaging, the legacy set-top devices require special dedicated equipment in the headend: an out of band modulator (OM) and a return path demodulator. The OM is a component of the cable television system that modulates the OOB message before communicating the message to the cable television network. The return path demodulator is a component of the cable television network that demodulates the OOB message and forwards the demodulated content to the network controller and/or to a conditional access system. Without these components in the headend of the cable television system, a legacy set-top device will not be able to receive OOB messaging from the cable television network, which is mandatory to properly receive a cable television signal in the DOCSIS DSG environment.

In operation, however, the OMs utilize a large amount of valuable RF bandwidth. While the loss of this RF bandwidth is undesirable, cable operators view this loss of RF bandwidth as a necessary evil to convert a cable network including one or more legacy set-top devices to a DOCSIS DSG environment. Currently, there is not an alternative in the art for providing OOB messaging functionality to legacy set-top devices in a DOCSIS DSG environment that minimizes the utilization of RF bandwidth.

Therefore, there is a need in the art for a method and apparatus for providing OOB messaging functionality to legacy set-top devices in a cable network utilizing or converting to DOCSIS DSG while minimizing the use of RF bandwidth. There is also a need in the art for a method and apparatus for providing OOB messaging functionality to these legacy set-top devices without introducing such a large amount of new equipment as to make such a method and apparatus uneconomical.

### SUMMARY OF THE INVENTION

The present invention overcomes the above-referenced deficiencies in the prior art by providing a method and apparatus for enabling OOB communication to a legacy set-top device, without requiring a DOCSIS tuner in the legacy set-top device. The present invention comprises two embodiments. The first embodiment comprises a one-way DSG to OOB transcoder for enabling OOB communication to the legacy set-top device, and the second embodiment comprises a two-way DSG to OOB transcoder for enabling communication to and from the legacy set-top device.

According to the first embodiment of the present invention, the one-way DSG to OOB captures the OOB message from the DSG tunnel in the DSG to OOB transcoder. The one-way DSG to OOB transcoder extracts the OOB message from the DOCSIS message, and modulates the OOB message into QPSK. The processed OOB message is then communicated to the legacy set-top device.

According to the second embodiment of the present invention, a return path demodulator in the two-way DSG to OOB transcoder provides two-way DOCSIS only communication to the legacy set-top device. In this second embodiment, the two-way DSG to OOB transcoder intercepts the QPSK path to the legacy set-top device, extracts the QPSK message(s), encapsulates the QPSK messages in DOCSIS messaging and transmits the return path over the DOCSIS network, rather than the legacy QPSK return path, thus creating a “pure” two-way DOCSIS network.

By incorporating the one-way DSG to OOB transcoder of the present invention, a cable television system converting to DOCSIS DSG, or utilizing DOCSIS DSG, does not require an OM. For a pure DOCSIS two-way system with the two-way DSG to OOB transcoder, an RPD and a network controller are not required to provide OOB messaging functionality to legacy set-top devices. Thus, such legacy set-top devices may function successfully in such a cable television system, while freeing up the bandwidth formerly utilized by the OM and the RPD.

### BRIEF DESCRIPTION OF THE DRAWINGS

For a fuller understanding of the present invention, reference is made to the following description taken in connection with the accompanying drawings, in which:

FIG. 1 is a block diagram illustrating a prior art cable television system, including a legacy set-top device, converting to DOCSIS DSG.

FIG. 2 is a block diagram of an exemplary system in accordance with the first embodiment of the present invention utilizing a one-way DSG to OOB transcoder 202.

FIG. 3 is a detailed block diagram of the one-way DSG to OOB transcoder 202 described in FIG. 2.

FIG. 4 is a simplified block diagram of an exemplary system 400 in accordance with the second embodiment of the present invention utilizing a two-way DSG to OOB transcoder 402.

FIG. 5 is a detailed block diagram of the two-way DSG to OOB transcoder 402.

FIG. 6 is a flow diagram illustrating the method of the first embodiment of the present invention from the perspective of the system 100.

FIG. 7 is a flow diagram illustrating the processing of an OOB message in accordance with the first embodiment of the present invention from the perspective of the one-way DSG to OOB transcoder 202.

FIG. 8 is a flow diagram illustrating the processing of a QPSK message from the legacy set-top device 102 in accordance of the second embodiment of the present invention from the perspective of the system 400.

FIG. 9 is a flow diagram illustrating the processing of a QPSK message from the legacy set-top device 102 in accordance with the second embodiment of the present invention from the perspective of the DSG to OOB transcoder 402.

FIG. 10 is a block diagram illustrating the process of transcoding from the proprietary OOB message to DOCSIS messaging.

### DETAILED DESCRIPTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention.

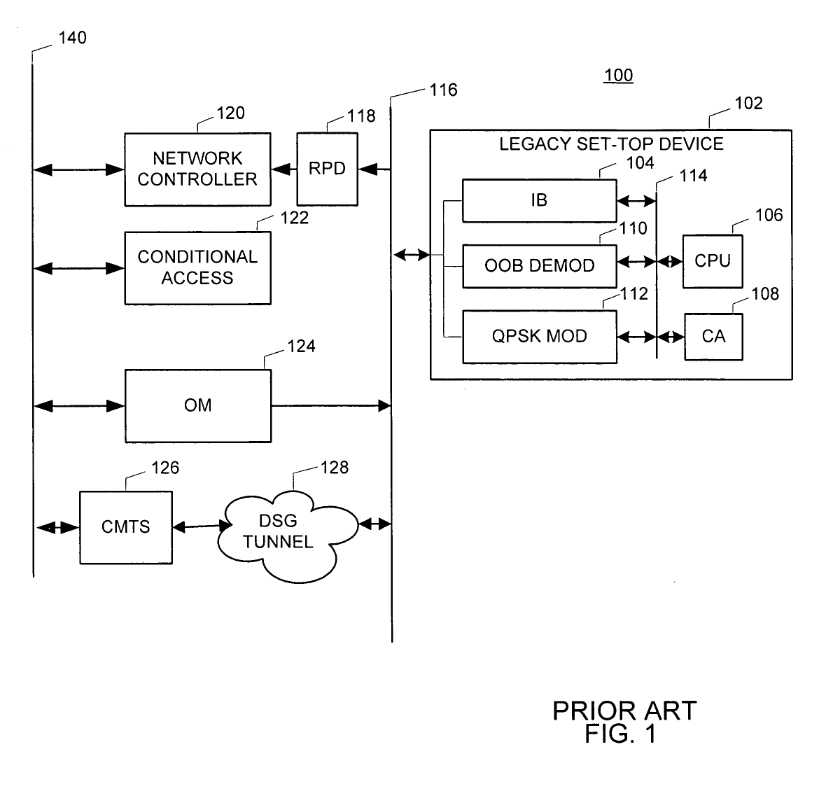

FIG. 1 is a block diagram illustrating a prior art cable television system, including a legacy set-top device, converting to DOCSIS DSG. Prior art cable television system 100 includes legacy set-top device 102. Communication gateway 114, which may comprise but is not limited to, a local bus architecture, couples the various components within the legacy set-top device 102. In-band modulator (IB) 104 modulates all in-band messages, i.e., messages communicated within the frequency range normally used for video/audio information transmission.

OOB demodulator 110 demodulates all OOB messages, i.e., messaging which uses frequencies outside the normal range of video/audio information-transfer frequencies. These OOB messages may comprise information including system information, electronic program guide information, emergency alert information, or other generic, non-proprietary information.

Central processing unit (CPU) 106 is a processing unit for executing instructions operative to enable operation of the legacy set-top device 102. Conditional access system 108 is utilized to decrypt video/audio services and provide local rights management services. QPSK modulator 112 modulates messages that are generated locally on the legacy set-top device 102 upstream to the return path demodulator (RPD) 118.

Network controller 120 is a proprietary messaging to Internet protocol/user datagram protocol (IP/UDP) proxy device that bridges certain applications that reside on the legacy set-top device 102 to a pseudo Internet protocol network (not shown). As a IP/UDP proxy device, network controller 120 provides information via IP packets or packets of information known as datagrams. Datagrams are a self-contained, independent entity of data which carry enough information to be routed to a destination.

Return path demodulator 118 receives the QPSK modulated signal from the cable plant 116, demodulates this signal, and communicates the demodulated signal originating from legacy set-top device 102 to the conditional access system 122 via a well-known communication backplane 140, an example of which may be Ethernet. The conditional access system 122 is responsible for the configuration of, rights management of and over-all control of all set-top devices that reside on the cable plant 116.

CMTS 126 manages multiple one-way broadcast channels on the one or more DOCSIS downstreams. Each DOCSIS downstream resides on a unique frequency and is identified by well-known media access control address, or “MAC address.” The CMTS 126 provides a DSG tunnel 128, which serves as a communication channel from the conditional access system 122 to DSG compatible set-top device 130. DSG tunnel 128 comprises an upstream and a downstream. The CMTS 126 may provide up to 8 DSG tunnel 128s to different DSG compatible set-top devices.

In prior art system illustrated in FIG. 1, cable television system 100 must utilize the OM 124 and return path demodulator 118 to provide OOB messaging to legacy set-top device 102, because the legacy set-top device 102 cannot successfully receive OOB messages from the CMTS 126 because of the lack of DOCSIS tuning capabilities. Because the OM 124 is a RF device, utilization of the OM 124 consumes RF bandwidth, which is an undesirable side effect of the cable television system 100.

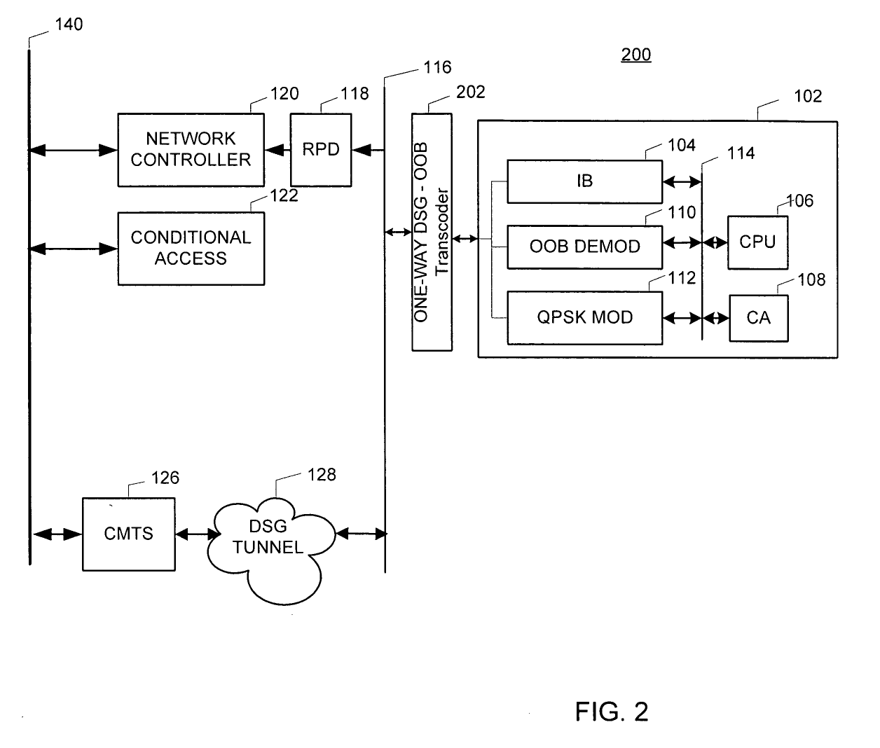

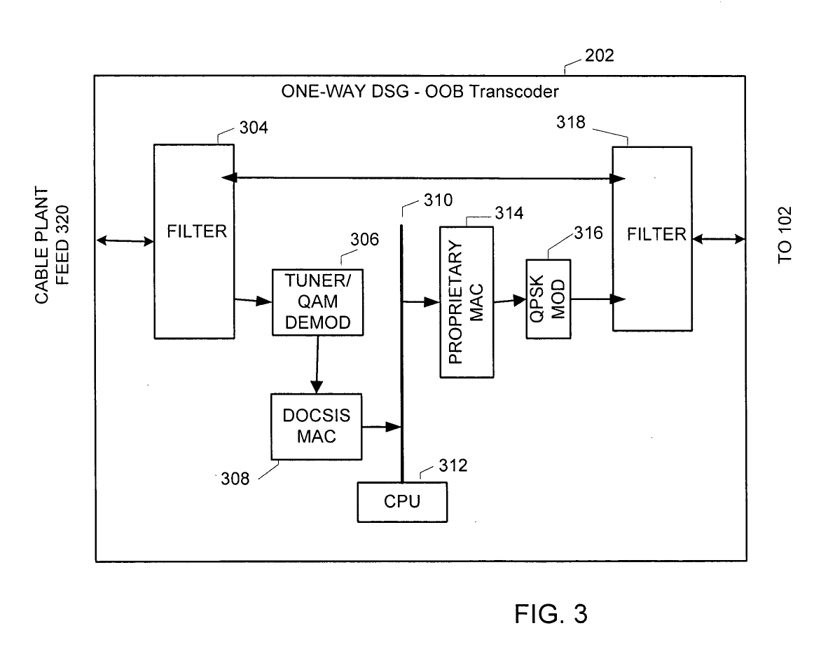

FIG. 2 is a simplified block diagram of an exemplary system in accordance with the first embodiment of the present invention utilizing a one-way DSG to OOB transcoder 202. Comparing system 200 to prior art system 100, OM 124 is no longer required in this system 200 as compared to system 100 as a result of the one-way DSG to OOB transcoder 202. Thus, the bandwidth consumed by that OM 124 is now available for other purposes. The details of the DSG to OOB transcoder 202 are discussed in greater detail in FIG. 3.

FIG. 3 is a detailed block diagram of the one-way DSG to OOB transcoder 202 depicted in FIG. 2. One-way DSG to OOB transcoder 202 comprises components that bridge the DSG tunnel 128 to the legacy set-top device 102. One-way DSG to OOB transcoder 202 only transcodes the downstream DSG tunnel 128, and thus, does not transcode the return path to the legacy set-top device 102.

One-way DSG to OOB transcoder 202 comprises a filter 304 that separates the DSG tunnel 128 from the remainder of the in-band traffic received from the cable plant 116 received from the cable plant feed 320. Filter 304 also combines the return path to the legacy set-top device 102 with the cable plant feed 320 thus allowing the QPSK OOB return signal to be transmitted back on to the cable plant 116.

Tuner/QAM demodulator 306, which receives the DSG tunnel 128 from the CMTS 126, tunes to the frequency carrying the DSG tunnel 128 and demodulates that DSG tunnel 128. The tuner/QAM modulator 306 then passes the DOCSIS MAC layer data to the DOCSIS MAC 308 for processing. The DOCSIS MAC 308 then extracts the individual UDP datagram(s), which comprise the original OOB message(s), targeted for the receiving device. CPU 312 receives the UDP datagram(s), and extracts the OOB message(s). The OOB message(s) content is communicated to the proprietary MAC 314, where it is reformatted to conform to the OOB system in legacy set-top device 102 prior to QPSK modulation. The reformatted OOB message(s) is then communicated to the QPSK modulator 316, where it is modulated and transmitted to the filter 318. Filter 318 combines the QPSK modulated OOB, which are then communicated to the legacy set-top device 102.

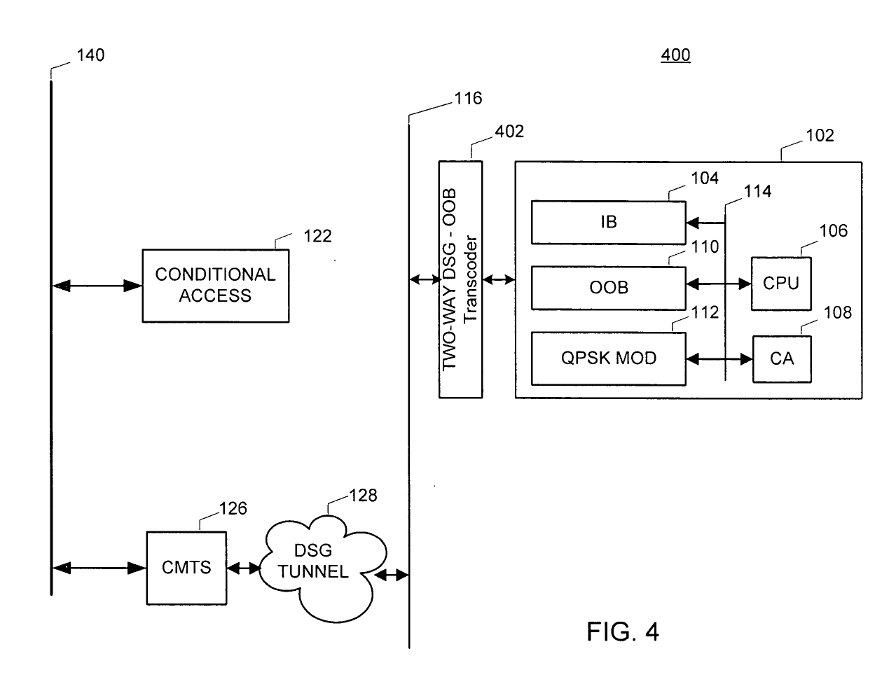

FIG. 4 is a simplified block diagram of an exemplary system in accordance with the second embodiment of the present invention utilizing a two-way DSG to OOB transcoder 402. The second embodiment of the invention permits two-way DOCSIS only communication to the legacy set-top device 102.

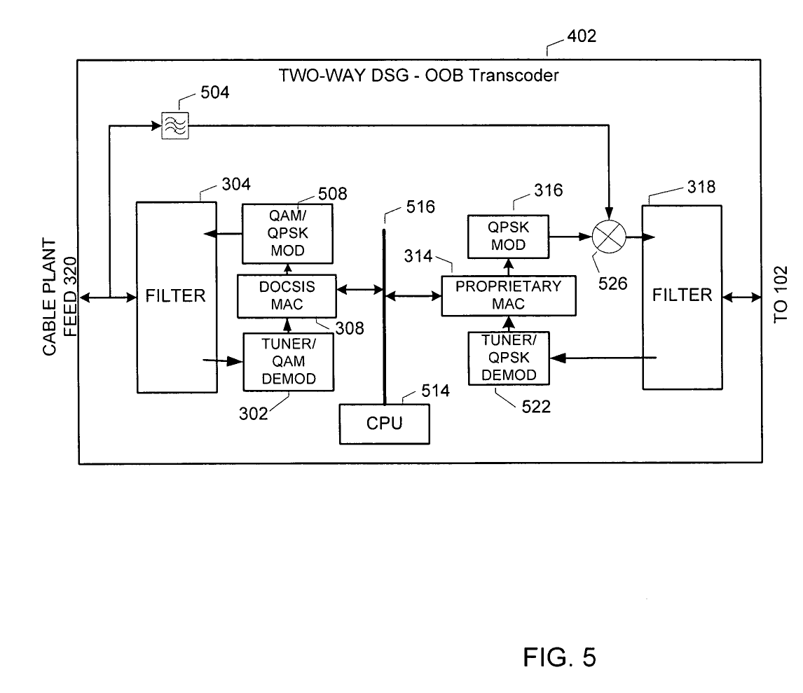

In this second embodiment, network controller 120, RPD 118 and OM 124 are not present in system 400. All OOB communications to legacy set-top device 102 are replaced by the DSG tunnel 128 and the DOCSIS return path, which are proxied by the two-way DCG to OOB transcoder 402. The details of the two-way DSG to OOB transcoder 402 are discussed in further detail in FIG. 5.

FIG. 5 is a detailed block diagram of the two-way DSG to OOB transcoder 402 as provided by the second embodiment of the present invention. To enable two-way DOCSIS communication to the legacy set-top device 102, two-way DSG to OOB transcoder 402 comprises tuner/QPSK demodulator 522, which tunes to the frequency carrying the proprietary OOB return channel. The two-way DSG to OOB transcoder 402 also demodulates any return communication from the legacy set-top device 102 intended for the DSG tunnel 128, which ultimately reaches the conditional access system 122. The practice of locating and tuning to the proprietary OOB return channel is well known to those familiar with the art.

Another component in the two-way DSG to OOB transcoder 402 is QAM/QPSK modulator 508. The QAM/QPSK modulator 508 modulates any communications from the legacy set-top device 102 to the DOCSIS return channel. When processing return traffic, the proprietary MAC 314 and the DOCSIS MAC 308 transcode the OOB message from legacy set-top device 102 to DOCSIS return.

Also present in the two-way DSG to OOB transcoder 402 in the second embodiment is a combiner 526 and an additional filter 504. Filter 504 only permits inband traffic from the received cable plant feed 320 to pass through to the legacy set-top device 102. Combiner 526 combines the filtered inband traffic with the transcoded and modulated OOB message(s), both of which are passed to the legacy set-top device 102.

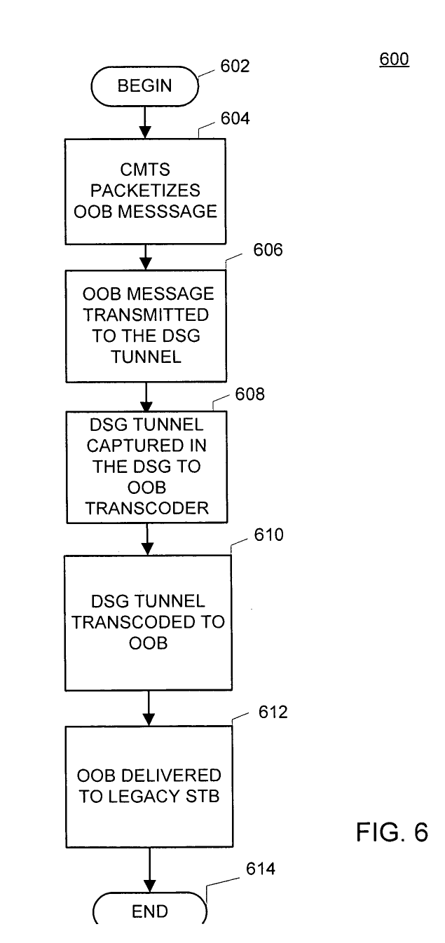

FIG. 6 is a flow diagram illustrating the method of the first embodiment of the present invention from the perspective of the system 100. Method 600 begins at step 602, and proceeds to the generation of an OOB message at step 604. This OOB message is typically generated in the CMTS 126, and is packetized by the CMTS 126. The OOB message is then communicated from the CMTS 126 to the DSG tunnel 128 at step 606.

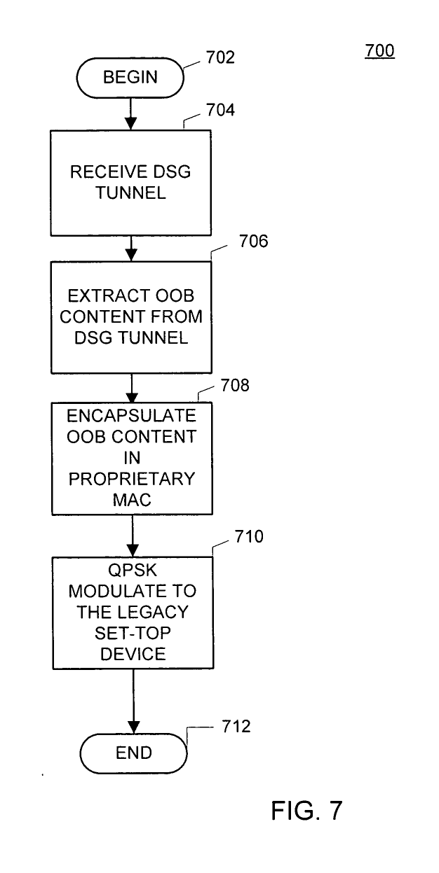

The one-way OOB to DSG transcoder 202 captures the OOB message from the DSG tunnel 128 at step 608. The one-way OOB to DSG transcoder 202 at step 610 modulates the OOB message to QPSK format. This task is performed by the method 700 described in FIG. 7. The QPSK message is the communicated to the legacy set-top device 102 at step 612, and method 600 concludes at step 614.

FIG. 7 is a flow diagram illustrating the processing of an OOB message in accordance with the first embodiment of the present invention from the perspective of the one-way DSG to OOB transcoder 202. Method 700 begins at step 702, and proceeds to the receipt of the OOB message from the DSG tunnel 128 at step 704.

At step 706, the CPU extracts the DOCSIS content from the OOB message, and at step 708, this DOCSIS content extracted from the CPU at step 706 is translated into QPSK. At step 710, the QPSK message is communicated to the legacy set-top device 102. Method 700 concludes at step 712 when the legacy set-top device 102 has received the QPSK message.

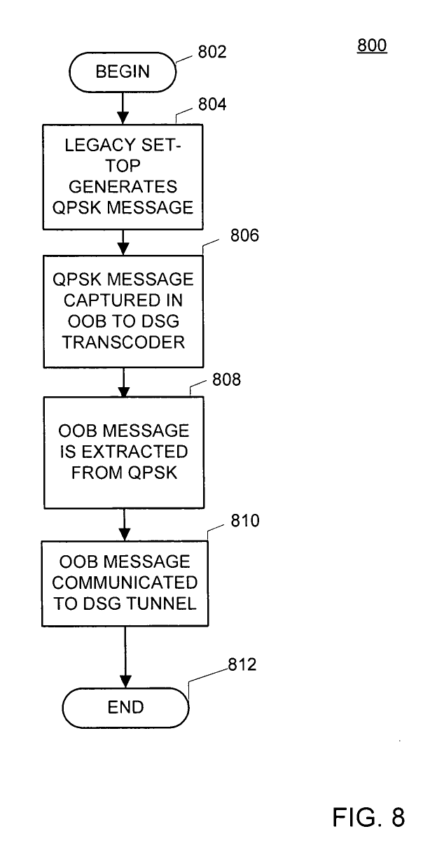

FIG. 8 is a flow diagram illustrating the processing of a QPSK message from the legacy set-top device 102 in accordance of the second embodiment of the present invention from the perspective of the system 400. Method 800 begins at step 802, and proceeds to the generation of a QPSK message within the legacy set-top device 102.

At step 804, the QPSK message is captured by the OOB to DSG transcoder. At step 806, the QPSK message captured by the OOB to DSG transcoder is reformatted into a OOB message. At step 808, the OOB message is communicated to the DSG tunnel 128. Method 800 then concludes at step 812.

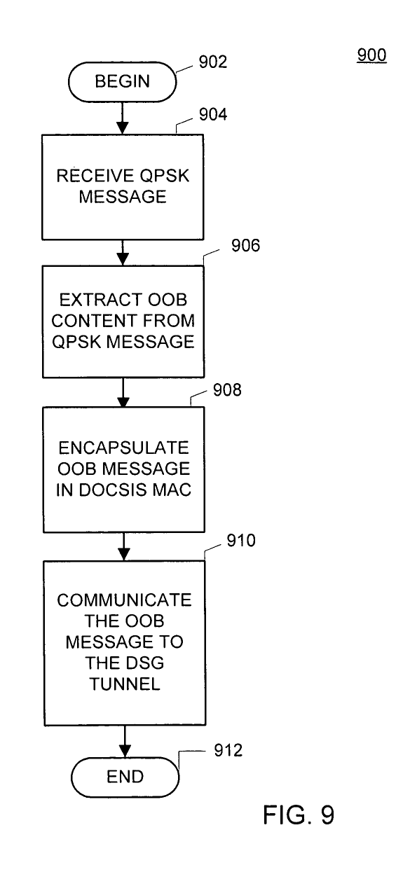

FIG. 9 is a flow diagram illustrating the processing of a QPSK message from the legacy set-top device 102 in accordance with the second embodiment of the present invention from the perspective of the DSG to OOB transcoder 402. Method 900 begins at step 902, and proceeds to the receipt of a QPSK message from the legacy set-top device 102 at step 904.

At step 906, the QPSK content is extracted from the QPSK message. This QPSK content is then translated into DOCSIS content, and encapsulated in an OOB message at step 908. The OOB message is communicated to the DSG tunnel 128 at step 910, and method 900 concludes at step 912.

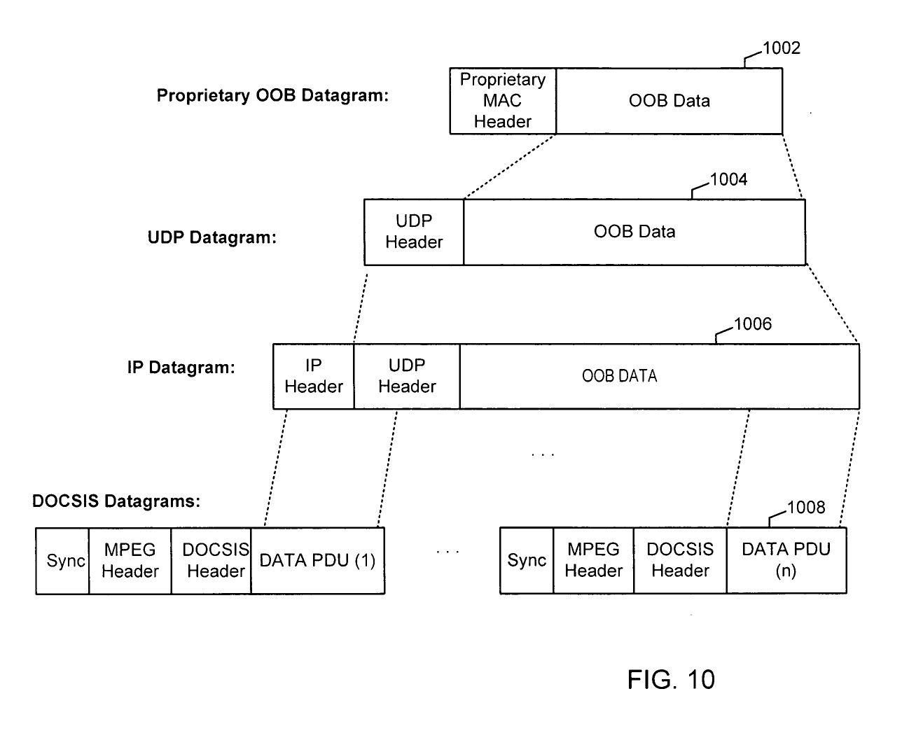

FIG. 10 is a block diagram illustrating transcoding process in accordance with the first embodiment and the second embodiment of the present invention. The trancoding process 1000 has two parts: 1) transcoding to OOB and 2) transcoding from OOB.

Transcoding to OOB starts with the decoding of the DOCSIS datagrams 1008, which are delivered in MPEG packets. The encapsulation and delivery of DOCSIS data in MPEG is well known to those familiar with the art and as such is not discussed in any further detail. The DSG to OOB transcoder extracts N number of data physical data units (PDUs) from N number of DOCSIS datagrams and reconstructs the IP datagram 1006 that has been encapsulated within the DOCSIS datagram. The number of data PDUs N is dependent on the size of the transmitted data.

The DSG to OOB then breaks down the IP datagram 1006 into the encapsulated UDP datagram 1004 and extracts the data payload from the UDP datagram 1004. The data payload from the UDP datagram is the OOB data that requires transcoding and retransmission to the legacy set-top device 102. The IP Header and the UDP Header may or may not comprise data required to format the proprietary MAC header of the proprietary OOB datagram 1002. If the headers contain required information, then the DSG to OOB transcoder utilizes the information when creating the proprietary MAC header.

After the proprietary OOB datagram 1002 is created, then DSG to OOB transcoder QPSK modulates and transmits the messages to the legacy set-top device 102 on a well-known frequency, the art of which is well-known.

It should be noted that transcoding from OOB return to DOCSIS return is the reverse process of the method 1000. The DSG to OOB transcoder extracts the OOB data from the proprietary OOB datagram 1002 and utilizes information from the proprietary MAC header to create the IP and UDP headers. The DSG to OOB transcoder then encapsulates the OOB data into a UDP datagram 1004 and subsequent IP datagram 1006. The DSG to OOB transcoder then fragments and encapsulates the IP datagram 1006 into DOCSIS datagrams and transmits the datagrams upstream to the CMTS 126, the art of which is well-known.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable carrier” for purposes of embodiments of the present invention may be any medium or transmission that can contain, store, communicate, propagate, or transport the program for use by or in connection with the instruction execution system, apparatus, system or device. The computer readable carrier can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, an and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in the following claims and/or to the particular embodiment disclosed as the best mode contemplated for carrying out this invention, but that the invention will include any and all embodiments and equivalents falling within the scope of the appended claims.

1. A method for communicating OOB messages comprising OOB proprietary content to a legacy set-top device in a DOCSIS DSG environment, said method comprising the steps of:
capturing an OOB message comprising DOCSIS content, said DOCSIS content comprising one or more DOCSIS datagrams wherein each said DOCSIS datagram comprises one or more PDUs and encapsulates a IP datagram;
transcoding the DOCSIS content in the OOB message into a QPSK message; and
communicating the QPSK message to the legacy set-top device.

2. The method of claim 1, wherein said capturing an OOB message comprising DOCSIS content comprises retrieving an OOB message from a cable plant.

3. The method of claim 1, wherein said transcoding the DOCSIS content in the OOB message into a QPSK message step comprises:
decoding the DOCSIS datagram;
decoding the IP datagram; and
modulating OOB proprietary content into a QPSK message.

4. The method of claim 4, wherein said decoding the DOCSIS datagram step comprises extracting N number of PDUs from N number of DOCSIS datagram, wherein N represents a number correlating with the size of the OOB message.

5. The method of claim 4, further comprising reconstructing said IP datagram.

6. The method of claim 3, wherein decoding the IP datagram comprises:
breaking down the IP datagram into a UDP datagram;
extracting OOB proprietary content from the UDP datagram.

7. A method for communicating messages from a legacy set-top device to a DO CSIS DSG environment, said method comprising the steps of:
capturing an QPSK message comprising QPSK content and a MAC header from the legacy set-top device;
transcoding the QPSK content in the QPSK message into an OOB message comprising one or more DOCSIS datagrams; and
communicating the OOB message to the DOCSIS DSG environment.

8. The method of claim 1, wherein transcoding the QPSK content in the QPSK message into an OOB message comprising DOCSIS content comprises extracting OOB data from the proprietary OOB datagram.

9. The method of claim 8, wherein extracting OOB data from the proprietary OOB datagram comprises utilizing information from the MAC header to create an IP header and a UDP header.

10. The method of claim 8, wherein said transcoding the QPSK content in the QPSK message into an OOB message comprising DOCSIS content further comprises encapsulating the OOB data in to an UDP datagram and a IP datagram.

11. The method of claim 10, further comprising encapsulating each IP datagram into a DOCSIS datagram.

12. An apparatus for enabling communication between a legacy set-top device and a DOCSIS DSG environment, said apparatus comprising:
a cable plant feed to a cable plant;
a first filter separating traffic from a DSG tunnel from in-band traffic received from the cable plant via the cable plant feed,
a tuner/QAM demodulator, which receives the DSG tunnel from a CMTS,
a DOCSIS MAC;
a central processing unit;
a QPSK modulator, and
a memory, said memory comprising a program module.

13. The apparatus of claim 12, wherein said program module comprises instructions operative to:
capture an OOB message comprising DOCSIS content comprising one or more DOCSIS datagrams, wherein each said DOCSIS datagram comprises one or more PDUs and encapsulates a IP datagram;
transcoding the DOCSIS content in the OOB message into a QPSK message;
communicating the QPSK message to the legacy set-top device.

14. The apparatus of claim 12, wherein said program module comprises instructions operative to:
capturing an QPSK message comprising QPSK content and a MAC header from the legacy set-top device;
transcoding the QPSK content in the QPSK message into an OOB message comprising one or more DOCSIS datagrams;
communicating the OOB message to the DOCSIS DSG environment.

15. The apparatus of claim 14, wherein said OOB message comprises a return path demodulator for demodulating communications from the legacy set-top device to the DSG tunnel 128.

16. The apparatus of claim 14, further comprising a network controller.

17. A computer-readable carrier including computer program instructions that instruct a computer to perform the steps of:
capture an OOB message comprising DOCSIS content comprising one or more DOCSIS datagrams, wherein each said DOCSIS datagram comprises one or more PDUs and encapsulates a IP datagram;
transcode the DOCSIS content in the OOB message into a QPSK message; and
communicate the QPSK message to the legacy set-top device.

18. The computer readable carrier of claim 17, wherein said capturing an OOB message comprising DOCSIS content comprises retrieving an OOB message from a cable plant.

19. The computer readable carrier of claim 17, wherein said transcoding the DOCSIS content in the OOB message into a QPSK message step comprises:
decoding the DOCSIS datagram;
decoding the IP datagram; and
modulating OOB proprietary content into a QPSK message.

20. The computer readable carrier of claim 19, wherein said decoding the DOCSIS datagram step comprises extracting N number of PDUs from N number of DOCSIS datagram, wherein N represents a number correlating with the size of the OOB message.

21. The computer readable carrier of claim 20, further comprising reconstructing said IP datagram.

22. The computer readable carrier of claim 19, wherein decoding the IP datagram comprises:
breaking down the IP datagram into a UDP datagram;
extracting OOB proprietary content from the UDP datagram.

23. A computer-readable carrier including computer program instructions that instruct a computer to perform the steps of:
capturing an QPSK message comprising QPSK content and a MAC header from the legacy set-top device;
transcoding the QPSK content in the QPSK message into an OOB message comprising one or more DOCSIS datagrams; and
communicating the OOB message to the DOCSIS DSG environment.

24. The computer readable carrier of claim 23, wherein transcoding the QPSK content in the QPSK message into an OOB message comprising DOCSIS content comprises extracting OOB data from the proprietary OOB datagram.

25. The computer readable carrier of claim 24, wherein extracting OOB data from the proprietary OOB datagram comprises utilizing information from the MAC header to create an IP header and a UDP header.

26. The computer readable carrier of claim 24, wherein said transcoding the QPSK content in the QPSK message into an OOB message comprising DOCSIS content further comprises encapsulating the OOB data in to an UDP datagram and a IP datagram.

27. The computer readable carrier of claim 26, further comprising encapsulating each IP datagram into a DOCSIS datagram.

28. An apparatus for receiving communications from a DOCSIS DSG environment comprising a DSG to OOB transcoder, said apparatus comprising:
an in-band modulator;
an out-of-band modulator;
a conditional access system;
a central processing unit; and
a QPSK modulator;
wherein said apparatus receives OOB messages from a DSG tunnel via the DSG to OOB transcoder, and communicates QPSK messages to the DSG tunnel via the DSG to OOB transcoder.

29. The apparatus of claim 28, wherein said OOB messages received from the DSG tunnel comprise OOB messages comprising DOCSIS content.

30. The apparatus of claim 29, wherein said DOCSIS content comprises one ore more DOCSIS datagrams.

31. The apparatus of claim 30, wherein each said DOCSIS datagram comprises one or more PDUs and encapsulates a IP datagram.
